(19) United States
(12) Patent Application Publication
(10) Pub. No.: US 2014/0136424 A1
(43) Pub. Date: May 15, 2014

(54) SYSTEM AND METHOD FOR CREATING A CUSTOMER PROFILE BASED ON HISTORY OF SERVICE

(71) Applicant: Florida Power & Light Company, Juno Beach, FL (US)

(72) Inventors: Anuja Nakkana, Palm Beach Gardens, FL (US); Radhakrishnan Swaminathan, Jupiter, FL (US); Hitendra Savdas, Port St. Lucie, FL (US); Paul Conway, Winter Park, FL (US)

(73) Assignee: Florida Power & Light Company, Juno Beach, FL (US)

(21) Appl. No.: 14/071,049

(22) Filed: Nov. 4, 2013

Related U.S. Application Data
(60) Provisional application No. 61/721,801, filed on Nov. 2, 2012.

(51) Int. Cl. G06Q 30/00

(52) U.S. Cl. CPC G06Q 30/016
USPC 705/304

(57) ABSTRACT

Disclosed is a system and method for providing a view of energy usage data or events generated by at least one AMI meter and customer profile information. The system and method involves the collection of information about a customer by different business units which are part of a service provider. The system and method includes a user computer having the capability of gathering data about a customer from the different business units, including energy usage data. The user computer may calculate a level of satisfaction of the customer with respect to that customer's interactions with the different business units and display icons reflecting such levels of satisfaction through use of widgets.

### CROSS REFERENCE TO RELATED APPLICATIONS

This application claims the benefit of U.S. Provisional Application No. 61/721,801, filed Nov. 2, 2012 the disclosure of which is hereby incorporated herein by reference in its entirety.

### FIELD OF THE INVENTION

The present invention relates to the field of data management and application of historical data to predict customer satisfaction. Specifically, the present invention is directed to a method and system for creating customer profiles based on a history of service.

### DESCRIPTION OF THE RELATED ART

Large enterprises face multiple challenges related to the collection and maintenance of data related to products or services they provide. For example, a large enterprise comprised of multiple business units or divisions may have different interactions with the same pool of customers of the enterprise. A customer may be satisfied with the services provided by one such business unit, but not equally satisfied with the quality of the service provided by another business unit. In a typical business model, these separate business units within a large enterprise keep data related to customer satisfaction in separate database systems. Customer satisfaction data is of extreme relevance to each business unit, as the data can be used to refocus services and improve the quality in the delivery of those services. However, the separate database systems run by the different business units are used by the business units to provide reports or data views that are very centric to what each business units does.

Thus, there is still a need in the art for a system that can be used by a large enterprise where the data kept by each separate business is compiled, analyzed and displayed uniformly across the enterprise without the need for a central database, and that further analyzes the data to create customer profiles that include a prediction of global customer satisfaction.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

One embodiment includes a computer-implemented method for providing a view of energy usage data or events generated by at least one AMI meter and customer profile information. The method may include receiving, from an application program executing on a client computing system, a request to initiate a view of profile information corresponding to a customer; transmitting a request for historical customer behavior information to a first database having stored therein a record of interactions between the customer and a first business unit of a service provider; transmitting a request for historical customer behavior information to a second database having stored therein a record of interactions between the customer and a second business unit of the service provider; transmitting to a third database a request for energy usage data measured by the at least one AMI meter and corresponding to the customer; responsive to the request to initiate the view, transmitting a graphical interface component to the requesting client computing system, wherein the graphical interface component is executed by the application program to compose a view of customer profile information which includes a first icon reflecting level of satisfaction of the customer with respect to interactions with the first business unit and a second icon reflecting level of satisfaction of the customer with respect to interactions with the second business unit.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates an exemplary system that may be used for implementing the disclosed application, in accordance with one embodiment;

FIG. 2 illustrates several sources of information that can be fed and displayed by the disclosed application in accordance with one embodiment;

FIG. 3 illustrates a high level view of personnel, across different business units, which may view customer profile information through the disclosed application, in accordance with one embodiment

FIG. 4 illustrates a view of a graphical user interface for the disclosed application in accordance with one embodiment;

FIG. 5 illustrates an account at a glance widget in accordance with one embodiment;

FIG. 6 illustrates a customer power quality and reliability history widget in accordance with one embodiment

FIG. 7 illustrates a customer billing and collections widget in accordance with one embodiment;

FIG. 8 illustrates a customer complaints widget in accordance with one embodiment;

FIG. 9 illustrates a customer contact history widget in accordance with one embodiment;

FIG. 10 illustrates a graphical user interface with a view of customer profile information in accordance with one embodiment;

FIG. 11 illustrates an STI-based architecture for the implementation of the disclosed system in accordance with one embodiment;

FIG. 12 illustrates a Service and Reliability Work widget in accordance with one embodiment;

FIG. 13 illustrates a Demand Side Management widget in accordance with one embodiment;

FIG. 14 illustrates a Claims widget in accordance with one embodiment;

FIG. 15 illustrates a Customer Details view in accordance with one embodiment;

FIG. 16 illustrates a Premise Troubleshooting view which may be accessed from the Customer Details view in accordance with one embodiment;

FIG. 17 illustrates a Ticket Details view which may be accessed through the Reliability History widget in accordance with one embodiment;

FIG. 18 illustrates a Restore Commitment view indicating how a utility responded to an outage in accordance with one embodiment;

FIG. 19 illustrates work ticket details from a job selected from the Work History widget in accordance with one embodiment;

FIG. 20 illustrates Complaint Details presented from clicking on an icon in a History view widget in accordance with one embodiment;

FIG. 21 illustrates interactions between a customer and a service provider which may be accessed from the Contact History widget in accordance with one embodiment;

FIG. 22 illustrates details for a rebate or survey experience in accordance with one embodiment; and

FIG. 23 illustrates specific details related to a claim in accordance with one embodiment.

### DESCRIPTION OF ILLUSTRATIVE EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

As will be appreciated by those skilled in the art, portions of the present invention may be embodied as a method, data processing system, or computer program product. Accordingly, these portions of the present invention may take the form of an entirely hardware embodiment, an entirely software embodiment, or an embodiment combining software and hardware aspects. Furthermore, portions of the present invention may be implemented as a computer program product on a computer-usable storage medium having computer readable program code on the medium. Any suitable computer readable medium may be utilized including, but not limited to, static and dynamic storage devices, hard disks, optical storage devices, and magnetic storage devices.

The present invention is described below with reference to illustrations of methods, systems, and computer program products according to embodiments of the invention. It will be understood that blocks of the illustrations, and combinations of blocks in the illustrations, can be implemented by computer program instructions, hardware devices, or a combination of both. These computer program instructions may be provided to a processor of a general purpose computer, special purpose computer, or other programmable data processing apparatus to produce a particular machine, such that the instructions, which execute via the processor of the computer or other programmable data processing apparatus, implement the functions specified in the block or blocks.

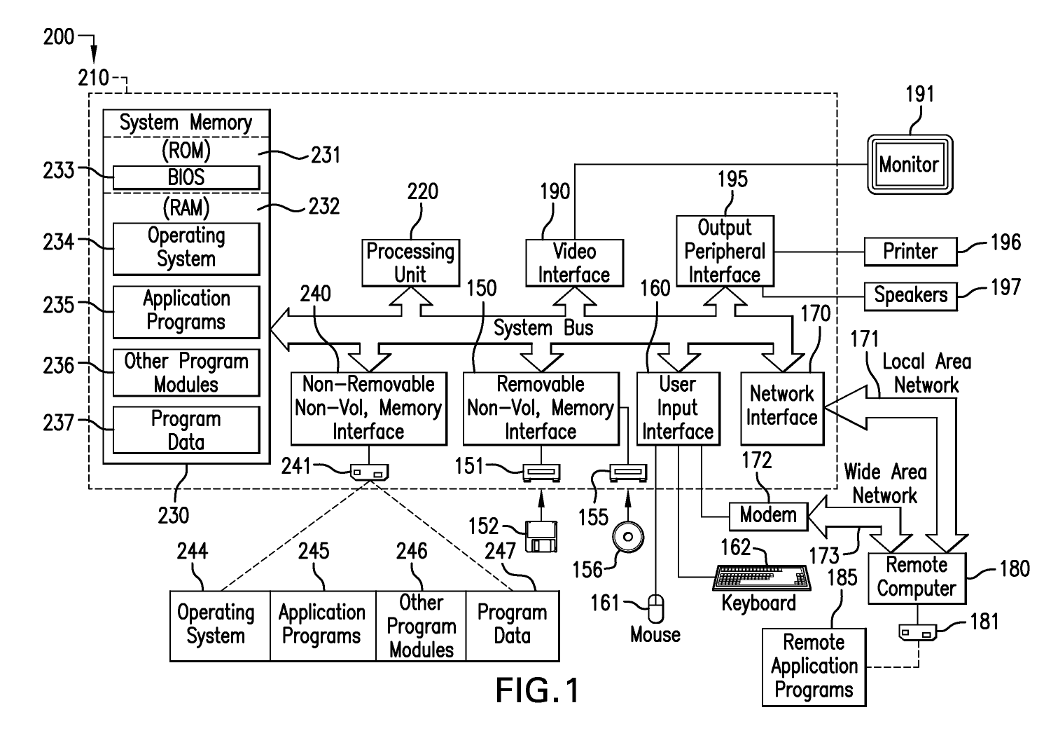

Embodiments of present invention may be implemented on one or more computing devices, including one or more servers, one or more client terminals, including computer terminals, a combination thereof, or on any of the myriad of computing devices currently known in the art, including without limitation, personal computers, laptops, notebooks, tablet computers, touch pads (such as the Apple iPad, SmartPad Android tablet, etc.), multi-touch devices, smart phones, personal digital assistants, other multi-function devices, stand-alone kiosks, etc. An exemplary computing device for implementing a computational device is illustrated in FIG. 1.

FIG. 1 illustrates an example of a suitable computing system environment 200 on which features of the invention may be implemented. The computing system environment 200 is only one example of a suitable computing environment and is not intended to suggest any limitation as to the scope of use or functionality of the invention. Neither should the computing environment 200 be interpreted as having any requirement relating to any one or combination of components illustrated in the exemplary operating environment 200.

The invention is operational with numerous other computing system environments or configurations. Examples of well known computing systems, environments, and/or configurations that may be suitable for use with the invention include, but are not limited to, personal computers, server computers, hand-held, notebook or laptop devices, touch pads, multi-touch devices, smart phones, other multi-function devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by one or more computing devices. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system that may be used for implementing the invention includes a computing device 210 which may be used for implementing a client, server, mobile device or other suitable environment for the invention. Components of computing device 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computing device 210 typically includes a variety of computer readable media. Computer readable media may be defined as any available media that may be accessed by computing device 210 and includes both volatile and nonvolatile media, removable and non-removable media. By way of example, and not limitation, computer readable media may include computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computing device 210. Combinations of the any of the above should also be included within the scope of computer readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computing device 210, such as during start-up, is typically stored in ROM 231. RAM 232 typically contains data and/or program modules that are immediately accessible to and/or presently being operated on by processing unit 220. By way of example, and not limitation, FIG. 1 illustrates operating system 234, application programs 235, other program modules 236, and program data 237.

The computing device 210 may also include other removable/non-removable, volatile/nonvolatile computer storage media. By way of example only, FIG. 1 illustrates a hard disk drive 240 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing device 210. In FIG. 1, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 162 and pointing device 161, commonly referred to as a mouse, trackball, touch screen, or multi-touch input device. Other input devices (not shown) may include a microphone, joystick, game pad, satellite dish, scanner, movement sensor device such as the Microsoft Kinect or the like. These and other input devices are often connected to the processing unit 220 through a user input interface 160 that is coupled to the system bus, but may be connected by other interface and bus structures, such as a parallel port, game port or a universal serial bus (USB). A monitor 191 or other type of display device may also be connected to the system bus 221 via an interface, such as a video interface 190. In addition to the monitor, computers may also include other peripheral output devices such as speakers 197 and printer 196, which may be connected through an output peripheral interface 195.

The computing device 210 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computing device 210, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computing device 210 is connected to the LAN 171 through a network interface or adapter 170. When used in a WAN networking environment, the computer 210 typically includes a modem 172 or other means for establishing communications over the WAN 173, such as the Internet. The modem 172, which may be internal or external, may be connected to the system bus 221 via the user input interface 160, or other appropriate mechanism. In a networked environment, program modules depicted relative to the computing device 210, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

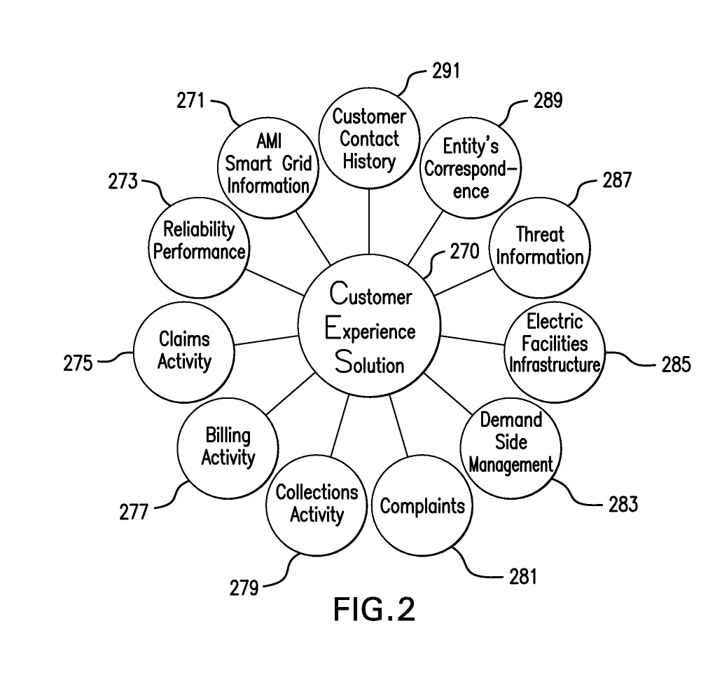

In the embodiment illustrated in FIG. 2, the system described in the present disclosure makes use of widgets to map data—from databases administered by separate business units in an enterprise—to an object. In the present disclosure, this system may be referred to as the Customer Experience Solution 270 (CES) system or application. In one embodiment, the CES system may be built through use of a Space Time Insight (STI) software application, which is a software development tool for integrating data sources into a visualization.

In one embodiment, the CES application accesses potentially different types of databases (Oracle, Sybase, etc.) and web services to obtain the data from the different database sources, where these services are made available to provide data to the CES application. In addition to displaying information residing in different databases, in one embodiment the CES application may perform calculations such as calculating number of customer complaints, counting events per icon displayed in a widget, duration of interruption in service, and others.

In one embodiment, the large enterprise having different business units is a utility and the collected data may include one or more of the following: customer contact history 291, business unit's correspondence 289, threat information 287 (if a customer exhibits or expresses any threatening conversation with field personnel or call center agents, a record of the exchange is captured in a simple database and a cautionary symbol may be displayed to alert customer facing agents should they be planning a visit), electric facilities infrastructure 285, demand side management information 283, complaints information 281, collections activity 279, billing activity 277, claims (e.g., request for re-imbursement for some loss or repair of property) activity 275, reliability and performance information 273, and AMI Smart Grid information 271.

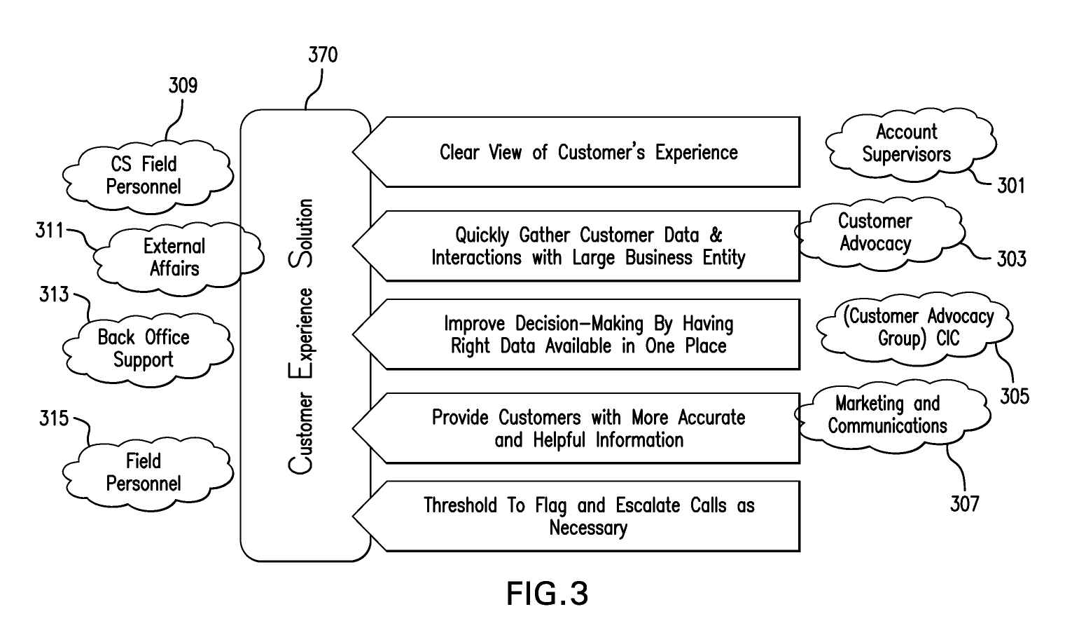

FIG. 3 illustrates a high level view of personnel, across the different business units, which may view customer profile information through the CES application, in accordance with one embodiment. For example, persons with access to the CES application may include customer service personnel 309, external affairs personnel 311, back office support personnel 313, field personnel 315, account supervisors 301, customer advocacy personnel 303, customer advocacy group personnel 305, and marketing and communications personnel 307. Through use of the CES application, users will gain a clear view of a customer's experience across the enterprise, will quickly gather customer data and customer interaction information with the enterprise, and will improve decision making by having pertinent customer data available in a single user interface or location. In addition, users will be able to provide customers with accurate and helpful information and will further be able to access thresholds to flag and escalate calls as necessary.

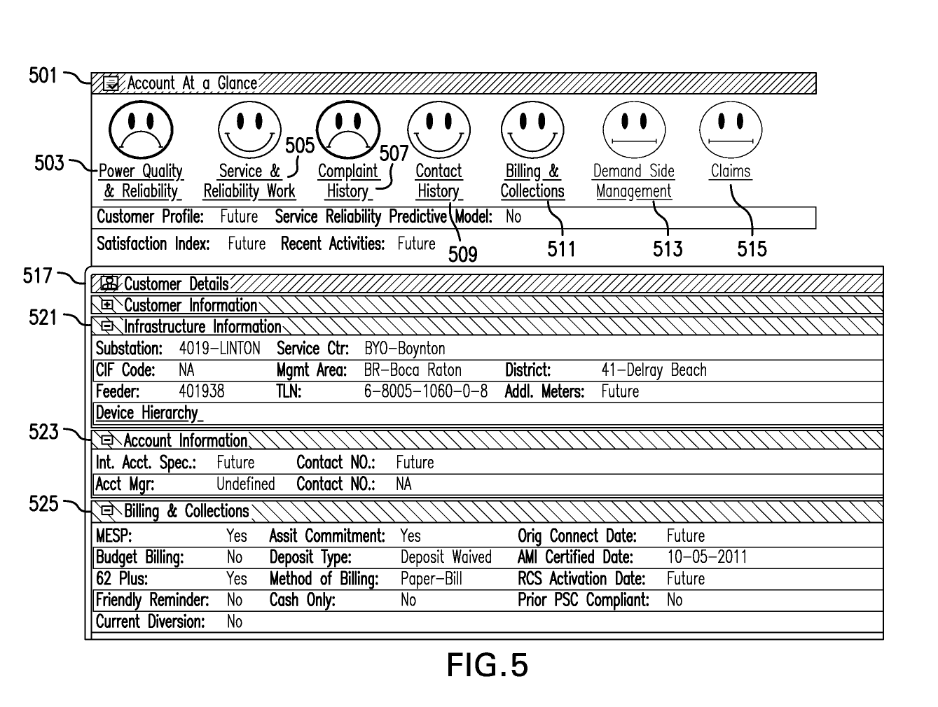

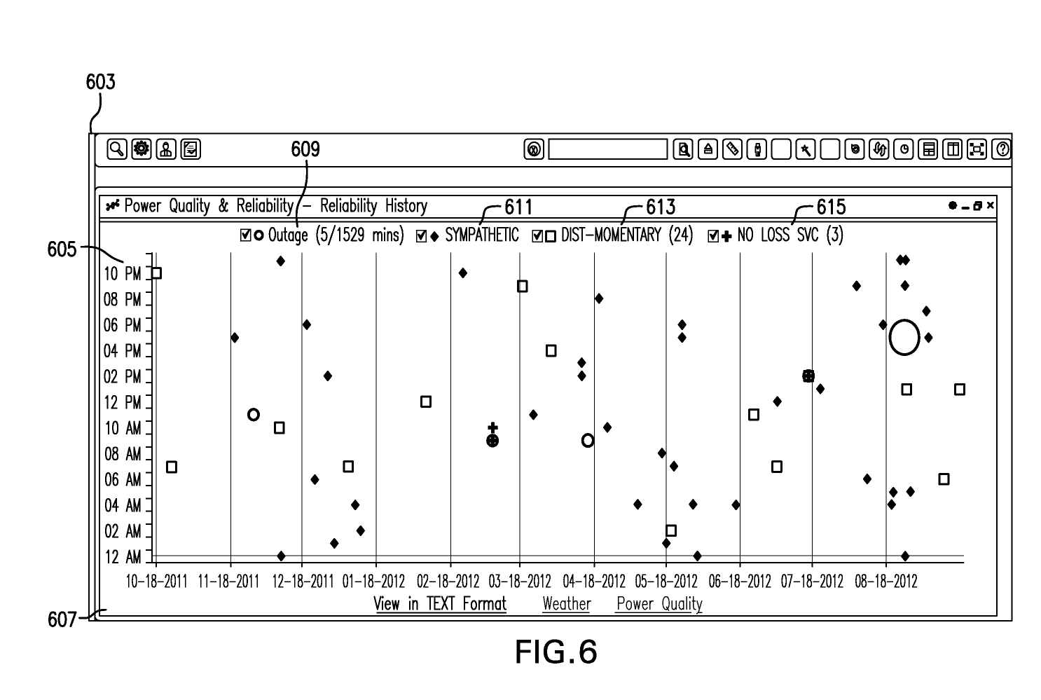

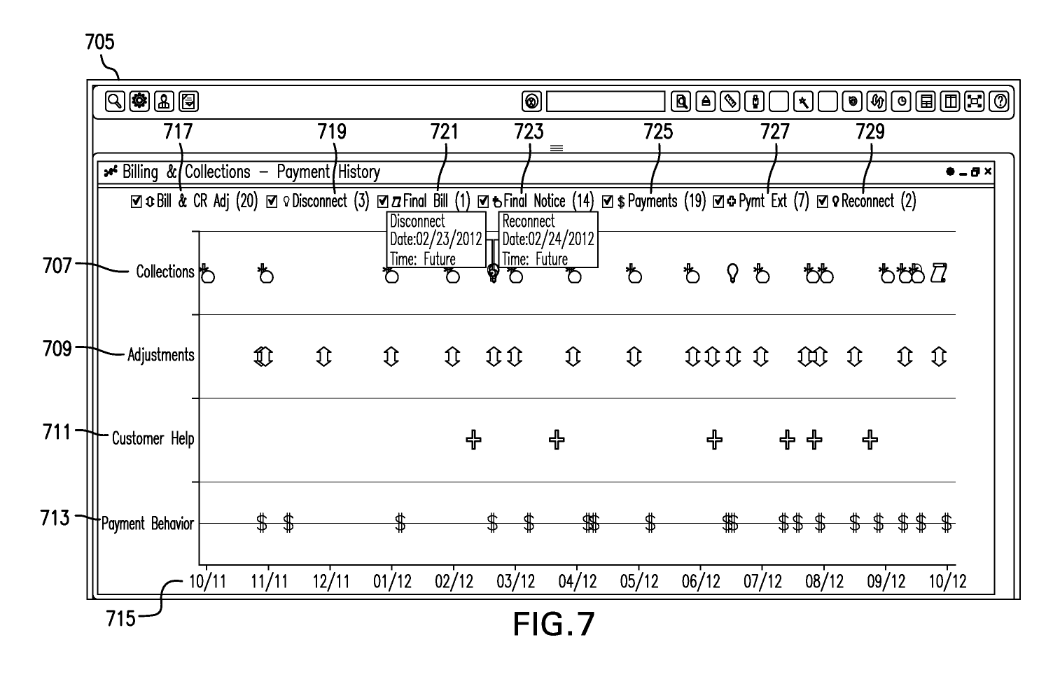

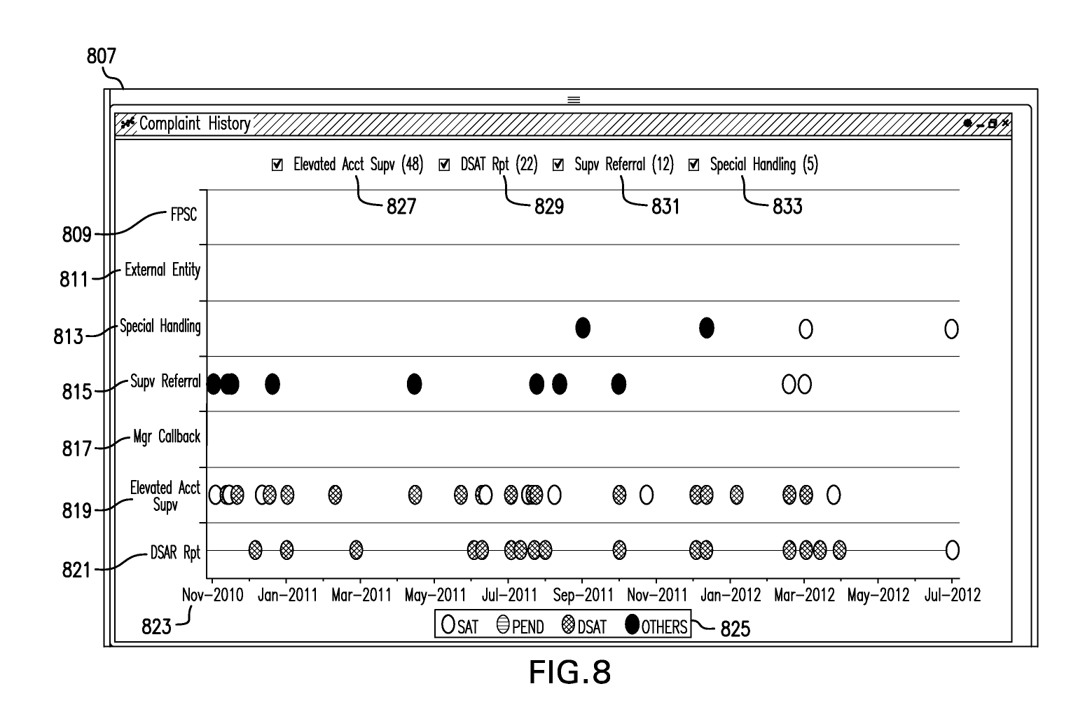

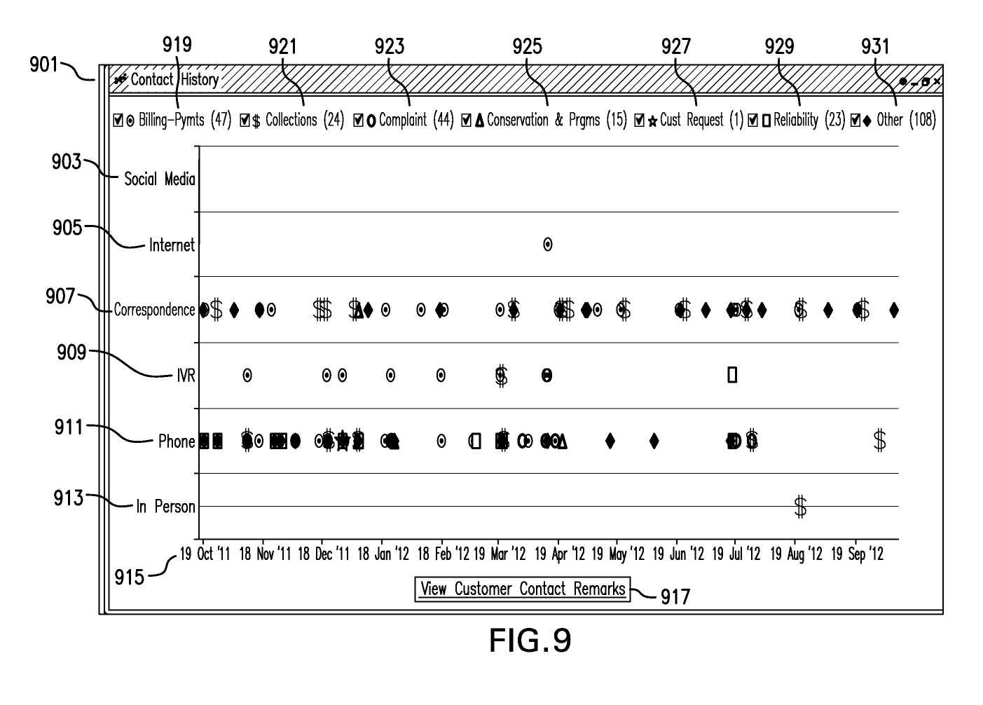

In one embodiment, the system of the present disclosure may generate several dashboards to display customer information. These may include an Account at a Glance Dashboard (FIG. 5), a Customer Power Quality and Reliability History dashboard (FIG. 6), a Customer Billing and Collections dashboard (FIG. 7), a Customer Complaints dashboard (FIG. 8), and a Customer Contact History dashboard (FIG. 9).

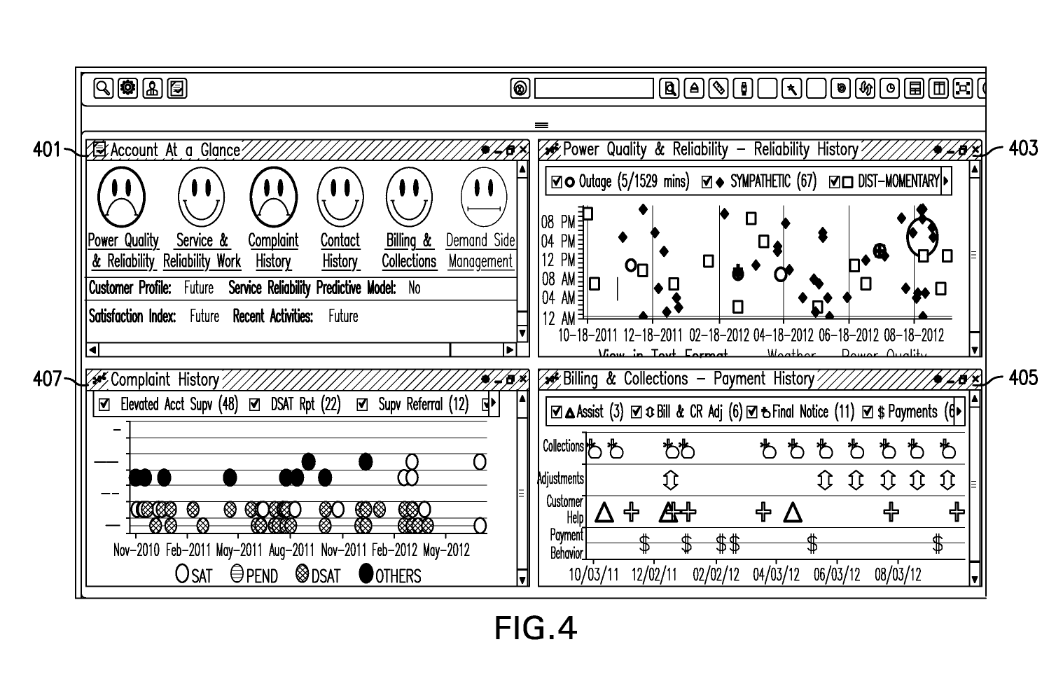

FIG. 4 illustrates a view of a graphical user interface (GUI) for the CES application in accordance with one embodiment. The GUI ties various widgets in the illustrated embodiment, specifically, and account at a glance widget or dashboard 401, a power quality and reliability widget or dashboard 403, a payment history widget or dashboard 405, and a complaint history widget or dashboard 407. In the illustrated embodiment, a single dashboard displays customer information, for example customer profile information, based on data acquired from the different business unit databases which, when collected from the different sources and displayed through a user interface, represents the customer profile information based on a history of services provided by the different business units. Use of widgets in computing apparatuses is known in the art. For example, U.S. Pat. Nos. 8,117,555; 8,255,186; and 8,266,537, incorporated herein by reference, disclose the use of widgets in computing devices for different applications.

The account at a glance widget or dashboard 401 may include information related to a customer level of satisfaction with respect to different services or aspects of the enterprise. More detailed customer profile information may be accessed by clicking on links displayed on this widget. The dashboard may also display a predictive model indicator (such as “Yes” or “No”) to indicate that an experience model used by a business unit (e.g., Distribution division of a utility) to elevate awareness of a potential Public Services Commission (PSC) complaint has been met. For example, a combination of outages and outage duration within a six month time span may be sufficient to trigger a formal complaint.

In one embodiment, the dashboard 401 may also display placeholders for design concepts to be addressed in the future. These placeholders are illustrated in FIG. 4 with respect to “customer profile information,” “satisfaction index,” and “present activities.”

The power quality and reliability widget or dashboard 403 may integrate data from transmission, distribution, and smart grid measurements for power delivery, trouble tickets for outages, and weather information that may contribute to the customer experience. It may also integrate power delivery data elements from the reliability history data widget and overlaid voltage fluctuations that may be felt by the customer.

The payment history widget or dashboard 405 may be used to visually present customer experience information with billing and collections activity based on payment patterns, and may be used to provide external assistance in support of efforts to encourage payment. The complaint history widget or dashboard 407 may integrate customer service and enterprise complaint tracking sources into a hierarchical framework based on organizational sensitivity. The range of information provided may expand visually from calls into care centers, to escalation to account supervisors and managers, to several levels above the care center of the response required to the public service commission. Dashboards 401, 403, 405, and 407 will be further explained in the following figures. The system in the present disclosure may also integrate additional dashboards. For example, the system may include a work request history of dashboard, demand side management dashboard, a claims history dashboard, or a threat history dashboard.

The work request history dashboard may integrate work orders performed by a distribution division in the enterprise which contributes to improving the customer experience or the response to a specific customer request. Associating data provided through the work request history dashboard to the customer-premise based on the work type of job and its alignment to feeder, lateral or transformer ordinate of the customer address.

The demand side management dashboard may organize the customer's use of the utility's supported programs to encourage energy efficiency and upgrade rebate programs. This dashboard may include a view for residential application or another view for commercial programs.

The claims history dashboard may organize customer claims activity across the customer service division, the distribution division, and vegetation management (e.g., the clearing of trees, plants that may affect the quality and reliability of electric services to the home or business). Visualization through the dashboard may demonstrate how the claim has been handled from payment to various in-process states, to payment denied.

The threat history dashboard may provide information regarding threats that is too sensitive to publish. Awareness of some potential risk is important to customer facing employees, particularly those that will be performing work at a customer location. CES may use a symbol to denote “caution” in the account at a glance watermarked on the account at a glance widget or dashboard.

Referring to FIG. 5, the account at a glance dashboard or widget 501 includes links to access other widgets to access information collected from different business units within the large enterprise: a power quality and reliability widget 503, a service and availability work widget 505, a complaint history widget 507, a contact history widget 509, a billing and collections widget 511, a demand side management widget 513, and a claims widget 515.

Through the account at a glance widget 501, a customer details view 517 may be accessed. Under the customer details view, more specific customer information 519 may be accessed. Customer information may include a customer's address, telephone number, e-mail address, etc.

In the illustrated embodiment, utility infrastructure information 521 may be displayed for the particular customer. Infrastructure information may include substation information, service center corresponding to that customer, critical infrastructure facilities (CIF) code, management area information (e.g., information about a service area defined by a Distribution business unit of a utility and which may include multiple service centers and substations), feeder identification (e.g., identification of a main circuit carrying electricity to population areas and ultimating the transformer (TLN) that connects individual meters), TLN, indication of additional meters, and district information (e.g., information about a segment of a larger service area, typically denoting the largest city or county reference).

In the illustrated embodiment, account information 523 may be displayed for the particular customer, including an Internal Account Specialist Information for major accounts, along with an account manager assigned to the account.

In the illustrated embodiment, billing and collections information 525 may be displayed for the particular customer. The information may reference various programs and identify include characteristics of the customer that would be insightful for the user of the system. For example MESP may indicate a need for medical equipment at a customer location (it may be considered a good practice to perform a service disconnect by being prepared for medical needs). Diversion may refer to a customer's tampering with the meter to avoid paying future usage amounts. The prior PSC complaint field elevates awareness that the customer person can (or has) created challenges with the utility's public oversight body.

FIG. 6 illustrates the customer power quality and reliability history widget 603 in accordance with one embodiment. The widget 603 displays the time of day 605 on the y-axis and displays the day/date information 607 on the x-axis. The widget 603 displays events related to the power service offered by the utility to its customers—indications ranging from loss of power, to flickering lights out at a residence. Some of the information displayed by the widget 603 may be provided by users of the CES system (e.g., an employee of the utility may enter information to indicate whether a customer of the utility that called to report an outage is sympathetic), and may also be provided by smart meters in an AMI network.

Referring to FIG. 6, power outages 609 may be represented by a dot or circle, with the size of the circle corresponding to the duration of the outage experienced by the customer. The widget 603 may also display information related to the customer's mood during a call (611), with this information being represented by a diamond in the figure. In FIG. 6, “dist-momentary” indicates the interruption in services originates from monitors in a Distribution business unit in a utility (as opposed to transmission or substation problems). Also, the “no loss SVC” or NLS may be defined as a type of trouble ticket indicating that the customer did not experience a power interruption from the utility's side of the meter.

FIG. 7 illustrates the customer billing and collections widget 705. The billing related data may be sent to the CES system from a customer service data warehouse. In FIG. 7, along the y-axis, four different categories of billing and payment data are displayed: collections information 707, adjustments information 709, customer help information 711, and payment behavior information 713. The x-axis corresponds to the month and year for which icons corresponding to billing and payment behavior information are displayed. These icons include a bill and credit adjustment icon 717, a disconnect icon 719, the final bill icon 721, a final notice icon 723, a payments received icon 725, a payment extension icon 727, and a reconnect icon 729. The widget 705 also displays summary information related to the number of icons displayed.

FIG. 8 illustrates the customer complaints widget 807. Along the y-axis, seven different categories of customer complaints are displayed: FPSC 809, external entity 811, special handling 813, supervisor referral 815, manager callback 817, elevated account supervisor 819, and dissatisfaction report 821. These represent a hierarchy of complaints from the bottom up: incoming calls can be escalated up to the account supervisor, to requesting a manager call back, etc. Special handling of complaints may be recognized internally as a sensitive issue requiring additional attention to research and resolve. The external entity may represent inquiries from the media about complaints received from “job on the street” interviews. FPSC represents complaints logged with the utility's PSC.

The x-axis corresponds to the month and year for which icons 825 corresponding to customer complaints are displayed (customer satisfied, resolution pending, customer satisfied, and others). The widget 807 may also calculate and display summary information, for example the number of elevated to account supervisor incidents 827, the number of dissatisfaction reports 829, the number of supervisor referrals 831, and the number of special handling incidents 833.

FIG. 9 illustrates the customer contact history widget 901. This widget may display inbound and outbound contact information and may be obtained from multiple business units and data warehouses. Along the y-axis, six different categories of contact channels (e.g., method used for contacting the customer or utility) are displayed: social media 903, Internet 905, correspondence 907, interactive voice response 909, telephone 911, and in-person contact 913. The x-axis corresponds to the date in which the contact took place. The icons displayed by the widget relate to the type of contact: billing-payments contacts may be represented by a bulls eye icon (with summary information represented by numeral 919); collections contacts may be represented by a dollar sign icon (with summary information represented by numeral 921); complaints may be represented by a circle icon (with summary information represented by numeral 923); energy conservation and programs contacts (e.g., contacts by customer to request information about energy conservation and rebate programs) may be represented by a triangle icon (with summary information represented by numeral 925); customer requests (trim a tree, fix a street light, etc.) may be represented by a star icon (with summary information represented by numeral 927); contacts related to reliability (e.g., customer may inquire about a power outage via telephone, Internet, IVR) may be represented by a square icon (with summary information represented by numeral 929); and other types of contacts (e.g., mass mailing) may be represented by a diamond icon (with summary information represented by numeral 931).

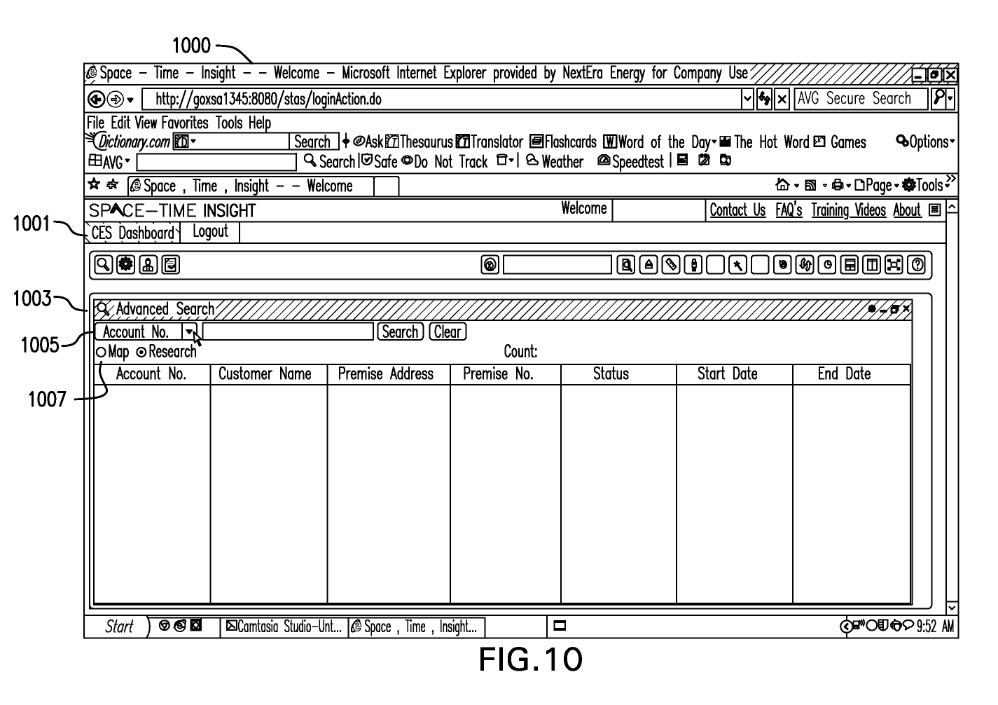

FIG. 10 illustrates a GUI with another view of the CES dashboard 1001. A user may use GUI 1000 to conduct an advanced search 1003 by entering, for example, a customer account number 1005. The GUI 1000 may offer users and option 1007 to display information overlaid on a map.

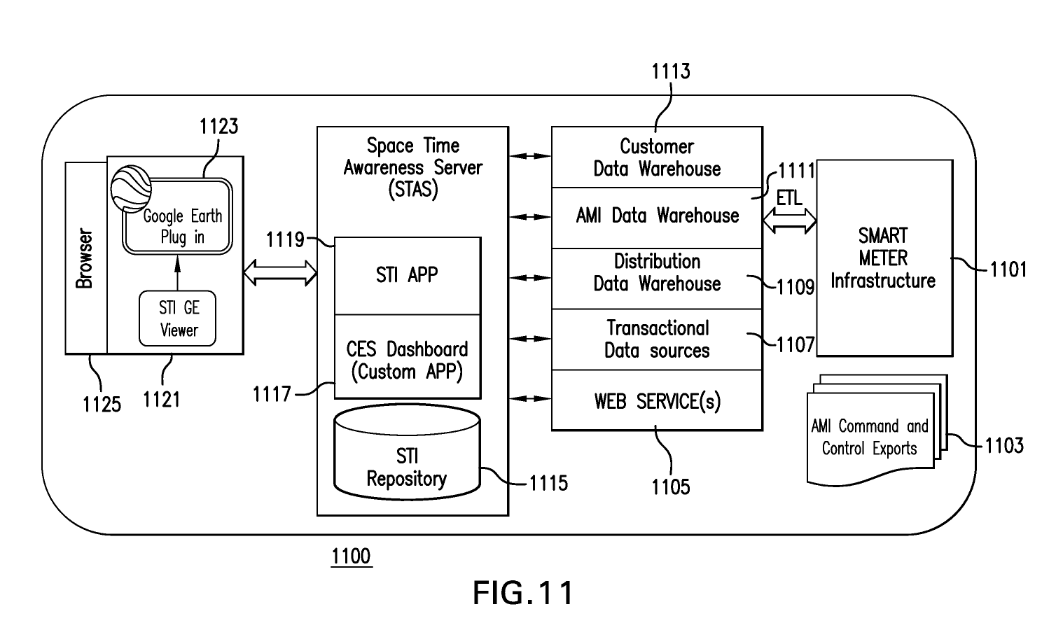

FIG. 11 illustrates an STI-based architecture for the implementation of the CES system. Specifically, the architecture 1100 may be used for integrating smart grid technologies with other third party tools, including STI, Google Earth, web browsers, etc. In FIG. 11, the Smart Meter Infrastructure 1101 may be defined as an operational data store for all meter data collected from scheduled read jobs and dynamic events triggered from the meter to alert to power down conditions. The AMI Command and Control Exports (1103) may be defined as monitoring tools for an Information Management (IM) business unit to manage the technical environment. These tools support the collection of inputs from the network (meters, relays, access points, scheduled read jobs to pull meter usage, etc.) and the pairing and export of specific data transactions to create data marts for enterprise business consumption. The data generated by the Smart Meter Infrastructure 1101 (or AMI network) is shared with a number of data warehouses through the use of web services, for further use by various widgets.

The Data Source Details below indicate where the data from the various widgets originate from:

| Data Warehouse | DataSource | Relevant Widget |
|---|---|---|
| AMI Data | AMI Network | Power Quality & Reliability |
| Warehouse (1111) | | |
| Distribution Data | Distribution | Service & Reliability Work |
| Warehouse (1109) | Network | Customer Details |
| | | Claims Widget |
| | | ITR-ETR |
| Transactional | Distribution | Service & Reliability Work |
| (Operational) Data | Network, | Device Hierarchy |
| Source (1107) | Transmission | Complaints Widget |
| | Network, and | Billing & Collections |
| | Customer Service | ITR-ETR |
| Customer Data | Customer Service | Customer Details |
| Warehouse (1113) | | Billing & Collections |
| | | Demand Side Management |
| | | Claims |
| | | Threats |
| | | Contact History |
| Web Services (1105) | Transmission | Power Quality & Reliability |
| | Network | |

Further referring to FIG. 11, the STI Repository (1115) may be defined as application libraries that support the executable applications; the CES Dashboard (1117) may be defined as the body or repository of widgets (visuals) to make up the CES application; the STI APP (1119) may be defined as a tool layer that enables the developed CES application to work; the STI GE Viewer (1121) may be defined as a tool component to present data on a Google Earth map; the Google Earth Plug-in (1123) is the tool from Google Earth that may be used for integration with the CES application via viewer (1121); and browser (1125) may be any web browser used to display STI applications.

In one embodiment of the invention, once the data is collected, rules are applied to the data in order to generate an index of relative level of customer satisfaction. Alternatively, predictive analysis can be applied to generate the index of relative level of customer satisfaction.

In one embodiment, the system of the present invention applies rules to predict or create an index of customer satisfaction with respect to particular services or interactions that take place with respect to one or more business units of a large enterprise. For example, referring to FIG. 8, which illustrates a view of the Customer Complaints dashboard, the following rules can be applied in generating a color-based index of customer satisfaction:

| | Complaint | | | | | | | Complaint | | Ocur- | | |
|---|---|---|---|---|---|---|---|---|---|---|---|---|
| # | Category | | Duration | Ocurrence | Status | Index | # | Category | Duration | rence | Status | Ind. |
| 1 | FPSC | Last | 12 months | 1>= | Any | RED | 2 | FPSC | 24 months | 1>= | Any | YLW |
| | | incident | | | | | | | | | | |
| | | within | | | | | | | | | | |
| 3 | External | Last | 12 months | 1>= | Any | RED | 4 | External | 24 months | 1>= | Any | YLW |
| | | incident | | | | | | | | | | |
| | | within | | | | | | | | | | |
| 4.1 | Spec. Handling | Last | 12 months | 1>= | Any | RED | 4.2 | Spec. Handling | 24 months | 1>= | Any | YLW |
| | | incident | | | | | | | | | | |
| | | within | | | | | | | | | | |
| 5 | Asuvp Referral | Greater | 12 months | 3>= | Any | RED | 6 | Asuvp Referral | 12 months | 2<+ | Any | YLW |
| | | than | | | | | | | | | | |
| | | three | | | | | | | | | | |
| 7 | MGR_Call Back | Greater | 12 months | 2> | Any | RED | 8 | MGR_Call Back | 12 months | 2<= | Any | YLW |
| | | than | | | | | | | | | | |
| | | two | | | | | | | | | | |
| 9 | ElevatedAcctSuv/ | Greater | 12 months | 3> | UNSAT | RED | 10 | ElevatedAcctSuv/ | 12 months | 3<= | Any | YLW |
| | DSAT | than | | | | | | DSAT | | | | |
| | | three | | | | | | | | | | |
| 12 | ElevatedAcctSuv/ | Greater | 6 months | 2>= | PSC | RED | 11 | ElevatedAcctSuv/ | 6 months | <2 | Any | YLW |
| | DSAT | than | | | | | | DSAT | | | | |
| | | one | | | | | | | | | | |
| | | | | | | GRN | 13 | ElevatedAcctSuv/ | 6 months | 5> | Any | YLW |
| | | | | | | | | DSAT | | | | |

Green—Happy Face (GRN)
No DSAT Rpt within the last 12 months
No Elev Acct Supv within the last 12 months
No Manager Callbacks within the last 12 months
Any number of Satisfied Customer Account Satisfaction Tracking (CAST) complaint captures within 12 months
No upper level tickets>6

Yellow (YLW)
One or more CAST entries (Customer Care (CC) Level) ending in resolution status of UNSAT within last 6 months (recent minor disappointment)
Six or more CASTS ending in any resolution status within last 12 months (demonstrates a pattern of frustration)
One or more ticket escalations from CC (ATKTS) entries ending in DSAT resolution status within last 6 months.
Four or more ATKTS in any resolution status within 12 months.
One or more CLOSED Manager Callback requests within the last 12 months
No upper level tickets>8
One or more redirected complaint entries (Primary Account Tracking or PART entries) (Exclude A, B and T) ending in any resolution status within last 24 months (complaint escalated above customer advocacy)

Red
One or more OPEN or HELD Manger Callback requests within last 12 months
Three or more ATkT entries, ending in DSAT resolution, within last 12 months
One or more PART entries (Exclude A, B and T) ending in any resolution status within last 12 months (complaint escalated above customer advocacy)

Another example of the application of rules to predict customer satisfaction is illustrated in FIG. 9 (the Customer Contact History dashboard). The following rules can be applied in generating a color-based index of customer satisfaction:

CONTACT

Green
Experience with Reasonable Metrics

Yellow
Three or more inbound channel contacts for Complaint activity in last 15 days
Four or more inbound channel contacts for Conservation and Prgms activity in last 10 days
Five or more inbound channel contacts for Reliability activity in last 10 days
Four or more inbound channel contacts for Customer Request activity in last 10 days
Four or more inbound channel contacts for Collections activity in last 10 days
Four or more inbound channel contacts for Billing-Pymt activity in last 10 days
Six or more inbound channel contacts for Other subject in last 10 days

Red
No Red for Contact History

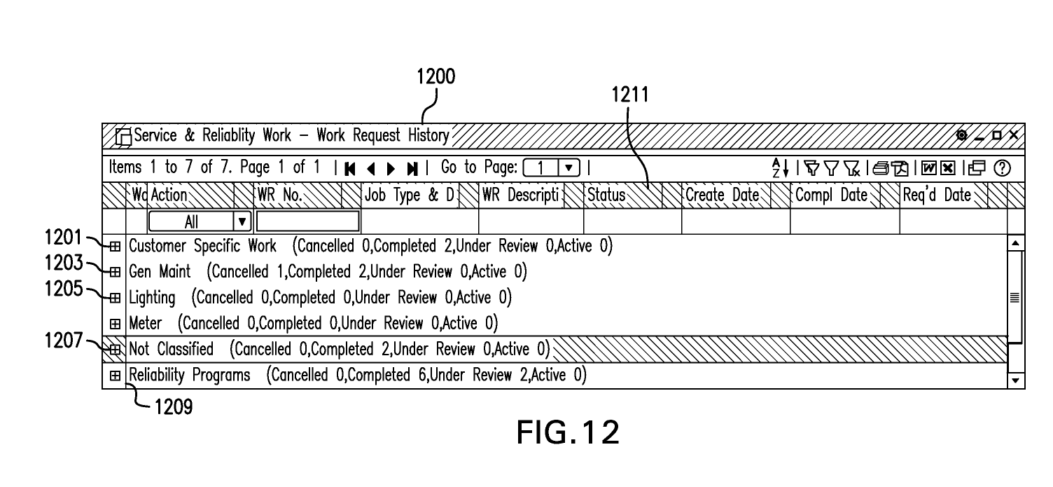

FIG. 12 illustrates a Service and Reliability Work widget 1200 in accordance with one embodiment.

In one embodiment, the Service and Reliability Work widget will provide the user with a summary of the work related to the customer's premise or feeder (main power line). This includes work requests for meter, general maintenance, lightning, claims, reliability and vegetation.

In one embodiment, there are six categories of work requests in this widget:
Meter
General Maintenance (1203 in the embodiment illustrated in FIG. 12)
Lightning (1205 in the embodiment illustrated in FIG. 12)
Claims
Reliability (1207 in the embodiment illustrated in FIG. 12)
Vegetation

In another embodiment, additional categories of work requests may be added, such as customer specific work (1201 in the embodiment illustrated in FIG. 12) and uncategorized work requests (1209 in the embodiment illustrated in FIG. 12).

In one embodiment, the widget 1200 may display, next to each subject, a count of relevant work in that category. The information may reflect the status of the work requests that are closed, active, completed, planned, etc. The user can expand and collapse a section by using the plus or minus sign to the left of each category.

The user can view the details of a specific work request by clicking on a hyperlinked number. This will launch a sub-widget titled Work Request Details. This will provide additional information such as work request number, job type and code, job description, status, create date, required date, scheduled date, status, status date and who the work request is assigned to (some of these are illustrated in FIG. 12 and denoted with numeral 1211).

In one embodiment, the Demand Side Management widget reflects the customer's history in:
Energy Surveys • Active On-Call program participation
DSM Program Participation
Pending Incentives and
Contractor Complaints

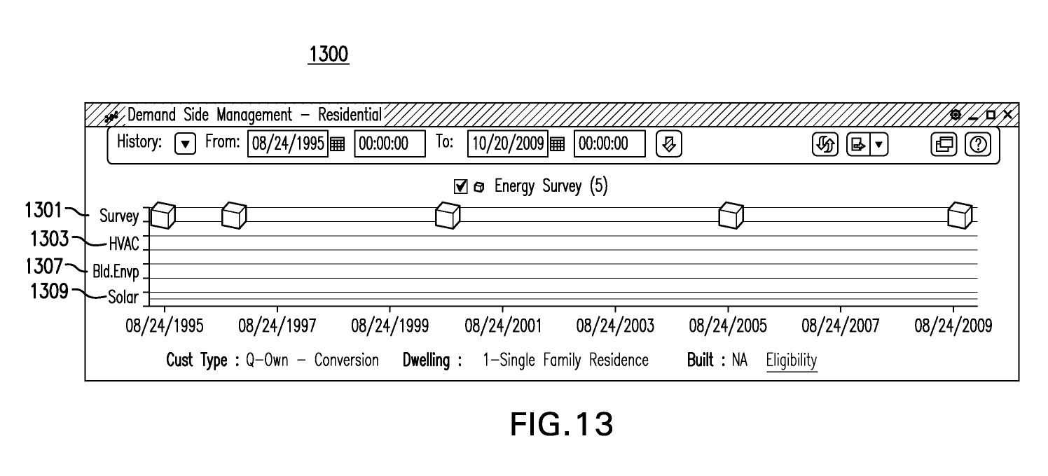

In one embodiment, the DSM widget contains several sub-widgets:
Demand Side Management—a graphical representation of DSM participation data points.
DSM Survey Details—This sub-widget (illustrated in FIG. 13) appears when a user clicks the Energy Survey data point on the graph. In one embodiment, four links within this sub-widget open additional windows.
Contractor Details—This sub-widget appears when a user clicks the Contractor Complaint data point on a graph.

The DSM sub-widget widget automatically detects whether the selected account is residential or business and displays the appropriate graph. The type of account is listed on the top toolbar of the widget window. The legend at the top of the graph contains a list of symbols that represent the data points on the graph. In the embodiment illustrated in FIG. 13 the only icon displayed corresponds to the Energy Survey. Next to each symbol is the number of data points displayed. The legend is dynamic and displays symbols that apply to the selected customer for the specified timeframe on the graph. A user may hover over any of the symbols to view additional information about a data point.

In one embodiment, five symbols are available on the legend and they may also be used or be the same for Residential and Business accounts. The symbols may include:
Energy Survey—an on-site energy evaluation/survey has been conducted for this account. To view additional details about the survey, a user can click the symbol.
Incentive Issued—an incentive has been issued for this account but has not been redeemed yet.
Participation—the customer has redeemed an incentive for this account.
On-Call—this account is active in one of the utility's On-Call programs.
Contractor Complaint—the customer has filed a complaint about a contractor for this account.

In one embodiment, the vertical axis on the left side of the graph 1300 lists the categories for DSM participation. The categories vary, depending on whether it is a residential or business account.

Residential Vertical Axis Categories:
Survey—on-site Home Energy Survey conducted at the customer's dwelling (1301 in FIG. 13).
On Call—the utility's residential appliance-based load control program that allows the utility to interrupt participating equipment when demand for electricity exceeds what the utility can generate.
Heating Ventilation and Air Conditioning (HVAC)—utility's residential high efficiency air conditioning and heating equipment program (1303 in FIG. 13).
DUCT—utility's residential cooling and heating duct system test and repair program.
Building Envelope (1305 in FIG. 13)
   Roof and Ceiling Insulation
   Reflective Roof Measures
Low Income—program for low-income dwellings, includes:
   Weatherization
   HVAC maintenance and
   High-Efficiency room air conditioners
Solar program (1307 in FIG. 13)
   Water heating
   Photovoltaic

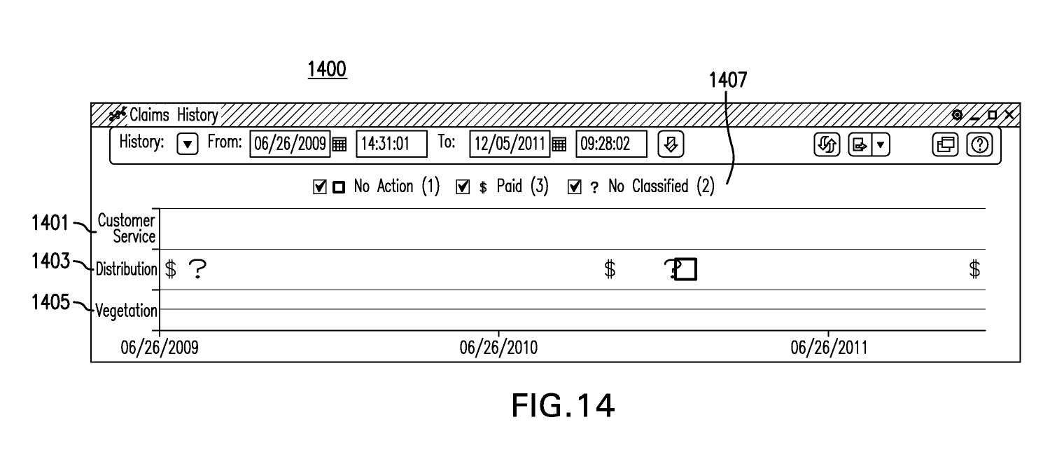

FIG. 14 illustrates a Claims widget 1400 in accordance with one embodiment. The widget 1400 may include a graphical representation of all claims data points associated to the customer's account.

The Claims widget 1400 provides a comprehensive view of the customer's claims history across three channels (the channel represents the business unit or group that originated the claim for the customer):
Customer Service (1401)
Distribution (1403)
Vegetation (1405)

The legend at the top of the graph contains a list of symbols that represent the data points on the graph. Next to each symbol is the number of data points displayed. The legend is dynamic and displays symbols that apply to the selected customer for the specified timeframe on the graph. A user may hover over any of the symbols to view additional information about a data point.

One embodiment of the claims history widget include eight symbols:
AMI (Smart Meter)—claim related to a Smart Meter.
Denied—claim denied.
No Action (illustrated in FIG. 14)—work request was closed with no action (i.e. never heard back from customer).
Paid (illustrated in FIG. 14)—claim paid to customer, contractor, or both.
Pending—open and active claim.
Referred—claim referred to another department (i.e. Legal).
Not Classified (illustrated in FIG. 14)—work request was closed without an action code.
Vegetation—claim related to vegetation.

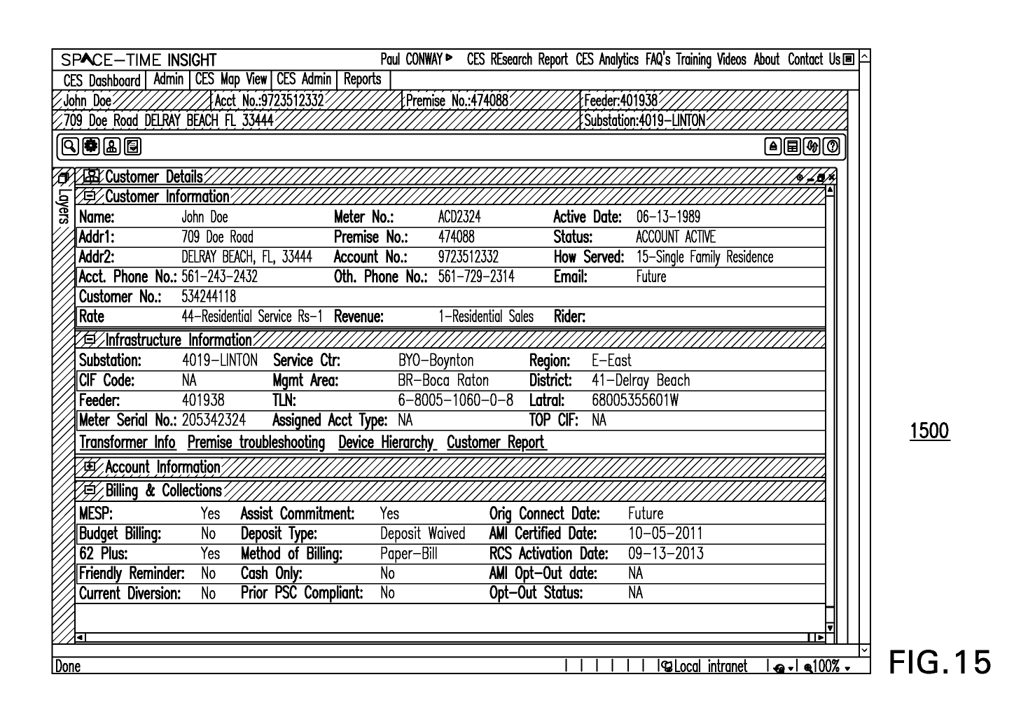

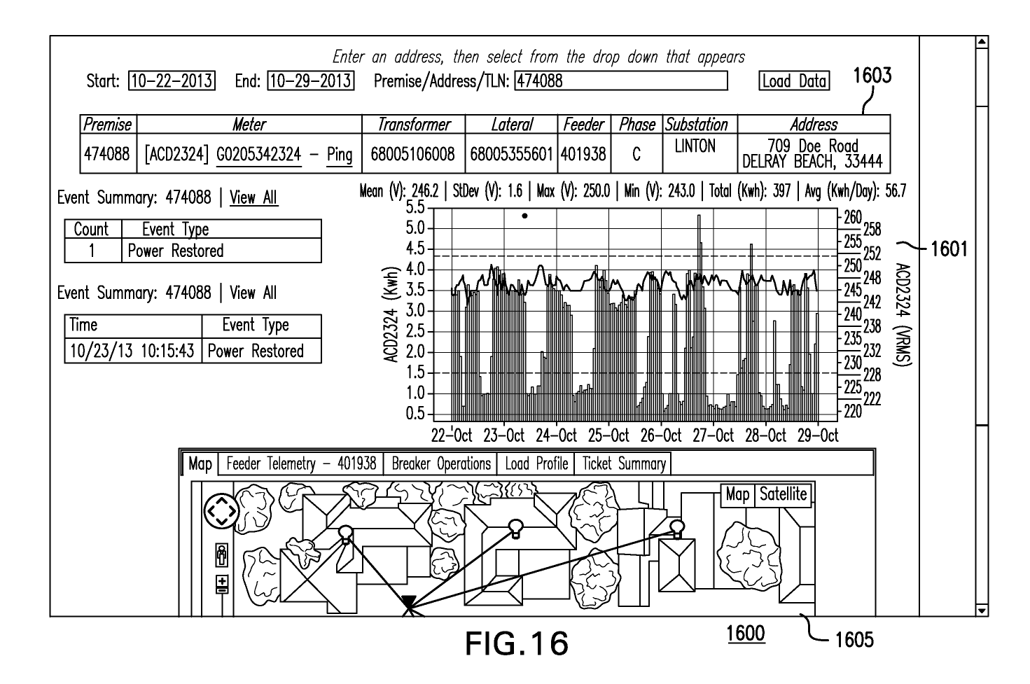

FIG. 15 illustrates a Customer Details view 1500 in accordance with one embodiment. The view 1500, which is an alternative view of view 517 in FIG. 5, organizes information about the customer and the customer account and provides hyperlinks to other dashboards in the CES system for voltage history, transformer reporting, etc. For example, the infrastructure information section in view 1500 includes a link for “Premise Troubleshooting” which leads the user to the graphical user interface 1600 in FIG. 16. The GUI 1600 includes a section 1603 information about a particular premise, such as meter identification, transformer identification, and customer address. The GUI 1600 also includes a graph 1601 detailing the voltage history for the customer premise. The GUI 1600 also displays a map 1603 showing several premises that receive power from a particular feeder.

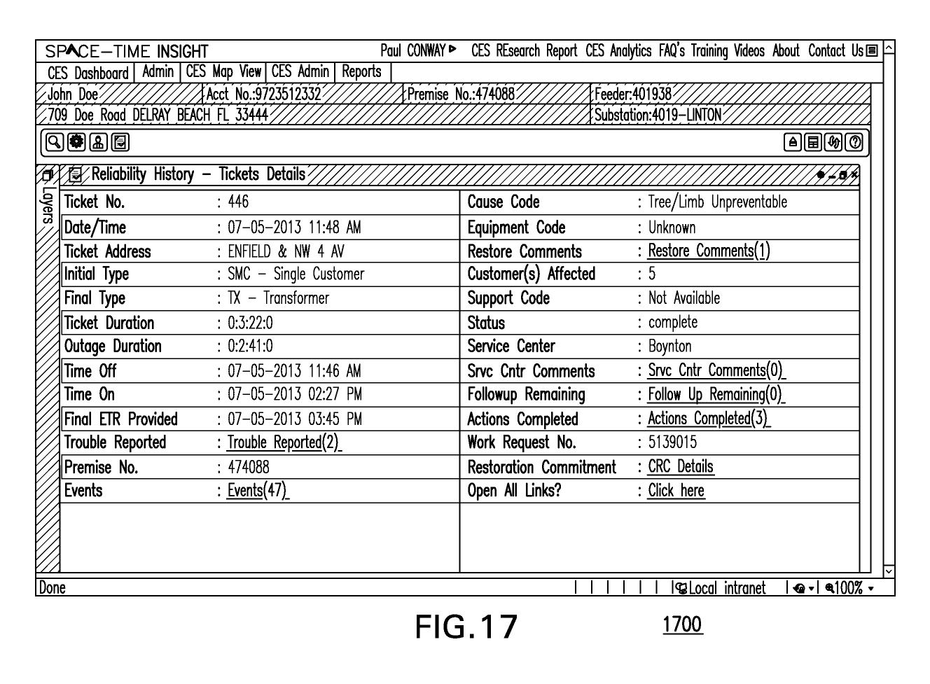

FIG. 17 illustrates a Ticket Details view 1700 which may be accessed through the Reliability History widget (FIG. 6) in accordance with one embodiment. The view 1700 provides a trouble ticket details for a selected event.

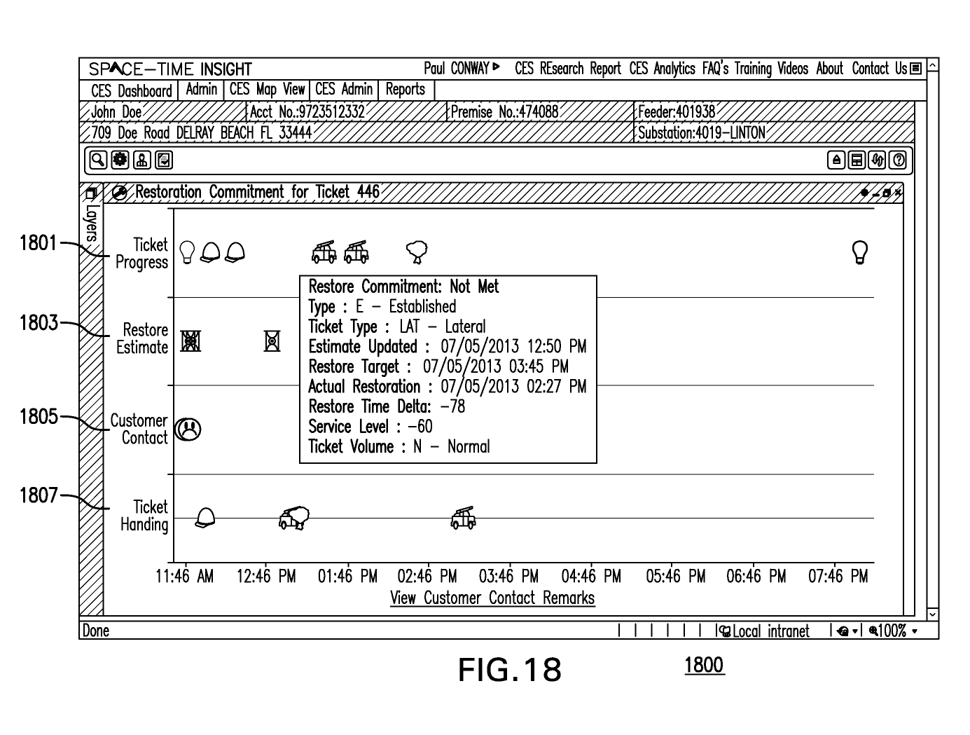

FIG. 18 illustrates a Restore Commitment view 1800 indicating how a utility has responded to an outage in accordance with one embodiment. In one embodiment the GUI 1800 may measure whether a utility has met a commitment to restore power within one hour from a last communication update. The y-axis includes several categories pertaining to service restoration: ticket progress 1801, restore estimate 1803, customer contact 1805, and ticket handling 1807. A legend with some of the icons that can be displayed follows:
[symbol] Time Off
[symbol] Part On
[symbol] Restore Time
[symbol] Power Restoration Specialist
[symbol] Service Crew
[symbol] Customer Restore Commitment (Green): Met
[symbol] Customer Restore Commitment (Gray): Not Estimated
[symbol] Customer Restore Commitment (Red): Not Met

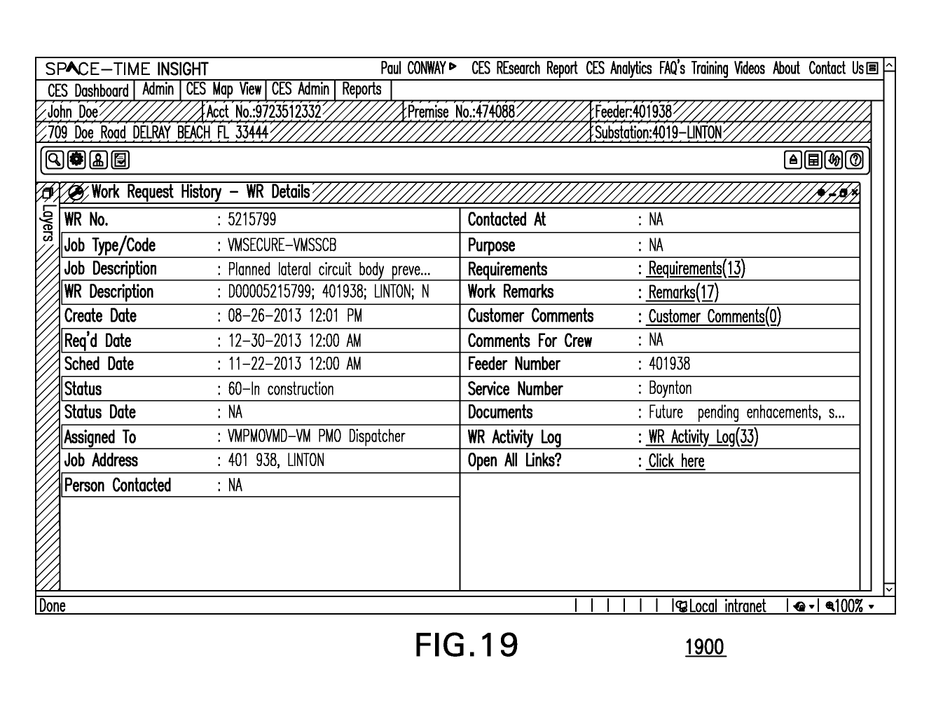

FIG. 19 illustrates work request (WR) ticket details 1900 from a job selected from the Work History widget (505 in FIG. 5) in accordance with one embodiment.

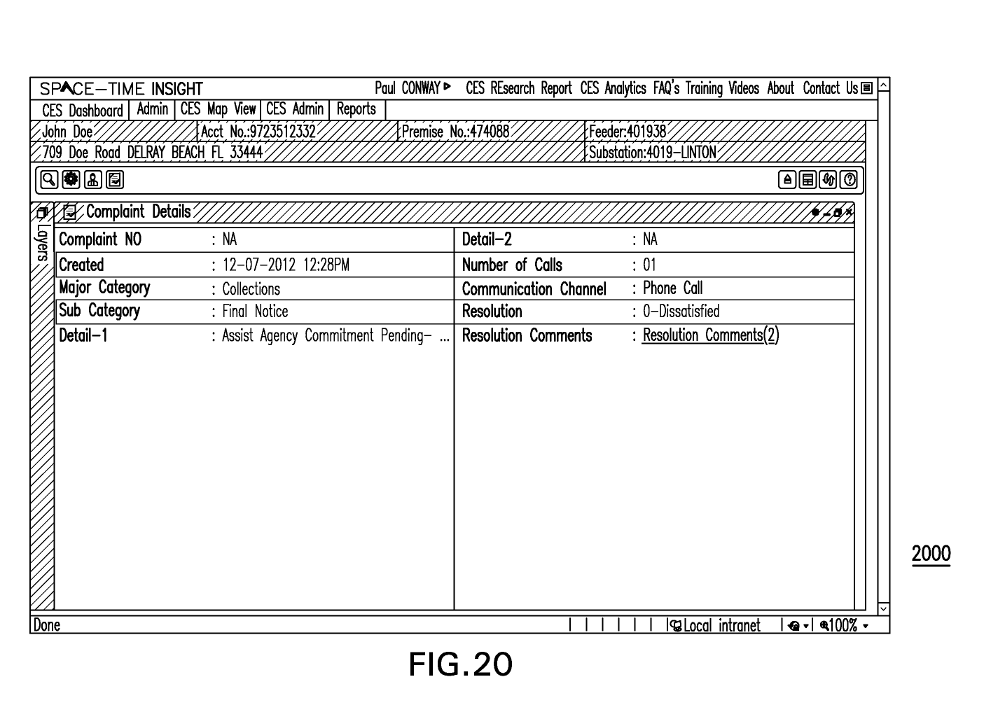

FIG. 20 illustrates Complaint Details 2000 presented from clicking on an icon in a history view widget in accordance with one embodiment.

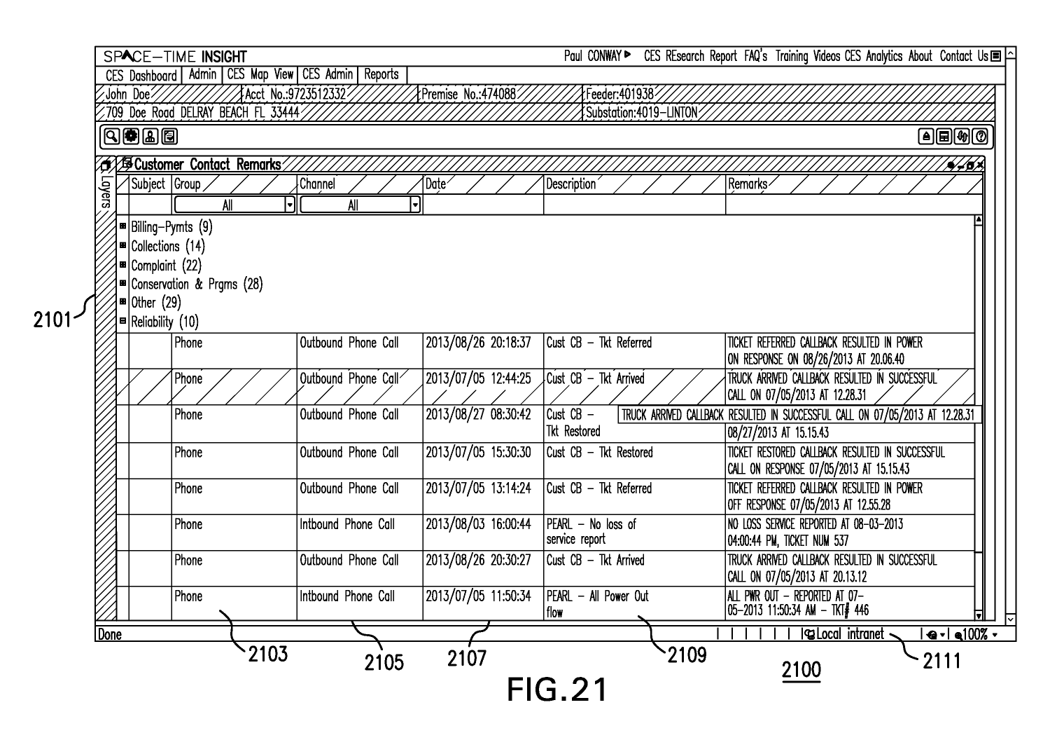

FIG. 21 illustrates a GUI 2100 displaying interactions between a customer and a service provider which may be accessed from a contact history widget in accordance with one embodiment. In the illustrated embodiment, the reliability view 2101 has been expanded. The reliability information is organized under the following categories: Group (2103), Channel (2105), Date (2107), Description (2109), and Remarks (2111). The Group (2103) relates to the method of contact from in-person field visit through phone, internet, and correspondence. Channel (2105) further breaks down Group(s) for inbound or outbound contact. Description (2109) may be a brief explanation for the touch point, with touch point being a 3-digit code either programmatically assigned to a contact from the supporting screen used to facilitate the conversation; or manually assigned by the service provider representative. In the figure, PEARL may be defined as a customer service system which provides a view into the trouble ticket system used by Distribution.

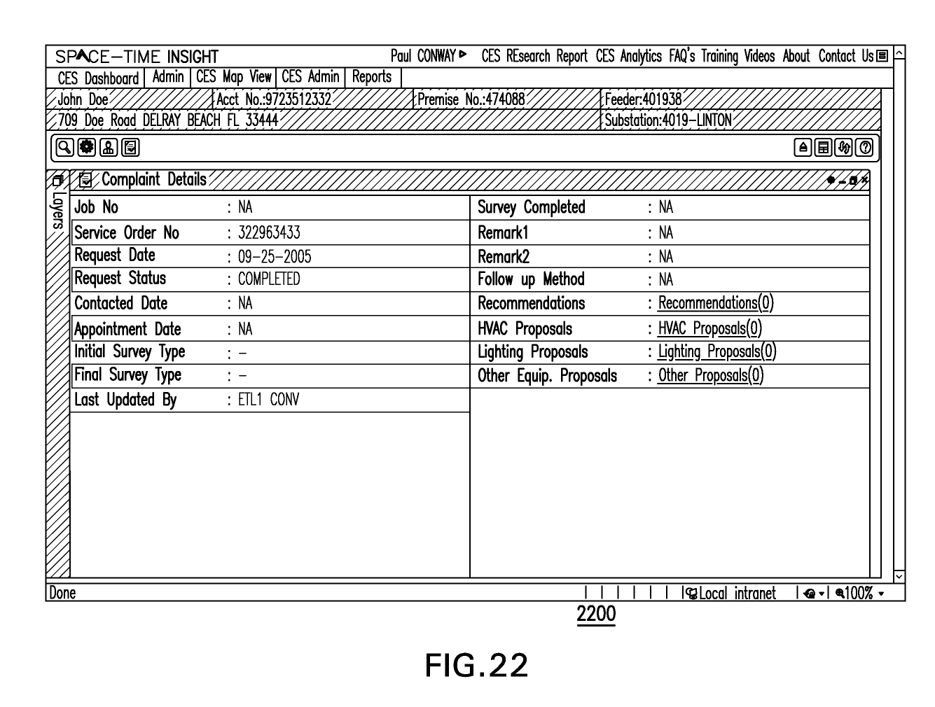

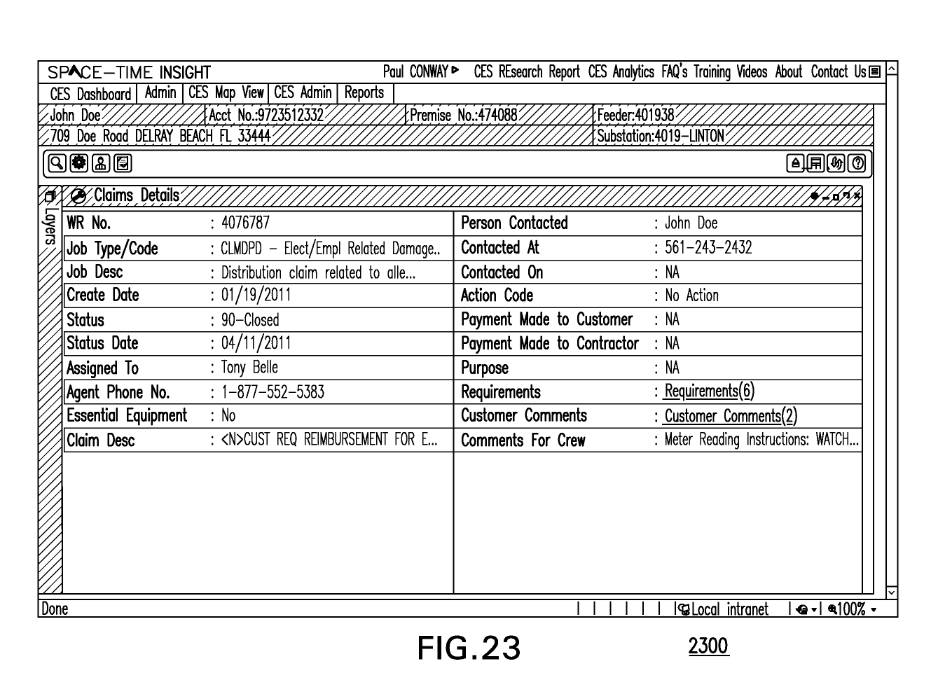

FIG. 22 illustrates a GUI 2200 displaying details for a rebate or survey experience in accordance with one embodiment. FIG. 23 illustrates a GUI 2300 displaying specific details related to a customer claim in accordance with one embodiment.

The foregoing description of possible implementations consistent with the present invention does not represent a comprehensive list of all such implementations or all variations of the implementations described. The description of only some implementation should not be construed as an intent to exclude other implementations. For example, artisans will understand how to implement the invention in many other ways, using equivalents and alternatives that do not depart from the scope of the invention. Artisans will also understand that while some of the disclosed embodiments relate to the power utility industry, the teachings described herein can be applied to other service providers or industries. Moreover, unless indicated to the contrary in the preceding description, none of the components described in the implementations are essential to the invention. It is thus intended that the specification and examples be considered as exemplary only, with a true scope and spirit of the invention being indicated by the following claims.

1. A computer-implemented method for providing a view of energy usage data or events generated by at least one AMI meter and customer profile information corresponding to a customer, the method comprising:
receiving, from an application program executing on a client computing system, a request to initiate a view of the customer profile information;
transmitting a request for first historical customer behavior information to a first database having stored therein a record of interactions between said customer and a first business unit of a service provider;
transmitting a request for second historical customer behavior information to a second database having stored therein a record of interactions between said customer and a second business unit of said service provider;
transmitting to a third database a request for energy usage data measured by the at least one AMI meter and corresponding to said customer; and
responsive to the request to initiate the view, transmitting a graphical interface component to the requesting client computing system, wherein the graphical interface component is executed by the application program to compose a view of the customer profile information which includes a first icon reflecting level of satisfaction of said customer with respect to interactions with said first business unit and a second icon reflecting level of satisfaction of said customer with respect to interactions with said second business unit.

2. The method of claim 1, wherein the first icon reflecting level of satisfaction is selected by applying rules to generate an index of customer satisfaction.

3. The method of claim 2, wherein said index is an emoticon-based index of customer satisfaction or a color-based index of customer satisfaction.

4. The method of claim 2, wherein the first icon reflecting level of satisfaction can be one of a substantially green image, a substantially yellow image, or a substantially red image.

5. The method of claim 2, wherein said rules are used to determine satisfaction level based on one or more of the following:
number of dissatisfaction reports;
number of elevated account supervisor incidents;
number of manager callbacks;
number of upper level tickets; or
number of complaints received.

6. The method of claim 5, wherein said rules are based on customer complaints.

7. The method of claim 2, wherein said rules are used to determine satisfaction level based on number of inbound contacts received by said service provider, said inbound contacts relating to one or more of the following activities:
complaints;
reliability;
conservation programs;
customer requests;
collections; or
bill payment.

8. The method of claim 1, wherein a first widget is configured to display said customer profile information.

9. The method of claim 1, wherein a first widget is configured to display said energy usage data, wherein said energy usage data comprises a history of voltage regulation for the customer's premises.

10. The method of claim 9, wherein said widget displays a threat alert.

11. A computer-readable storage medium containing a data server application, which when executed on a processor is configured to perform an operation providing a view of energy usage data or events generated by at least one AMI meter and customer profile information corresponding to a customer, the operation comprising:
receiving, from an application program executing on a client computing system, a request to initiate a view of the customer profile information;
transmitting a request for first historical customer behavior information to a first database having stored therein a record of interactions between said customer and a first business unit of a service provider;
transmitting a request for second historical customer behavior information to a second database having stored therein a record of interactions between said customer and a second business unit of said service provider;
transmitting to a third database a request for energy usage data measured by the at least one AMI meter and corresponding to said customer; and
responsive to the request to initiate the view, transmitting a graphical interface component to the requesting client computing system, wherein the graphical interface component is executed by the application program to compose a view of the customer profile information which includes a first icon reflecting level of satisfaction of said customer with respect to interactions with said first business unit and a second icon reflecting level of satisfaction of said customer with respect to interactions with said second business unit.

12. The computer-readable storage medium of claim 11, wherein the first icon reflecting level of satisfaction is selected by applying rules to generate an index of customer satisfaction.

13. The computer-readable storage medium of claim 12, wherein said index is an emoticon-based index of customer satisfaction or a color-based index of customer satisfaction.

14. The computer-readable storage medium of claim 12, wherein the first icon reflecting level of satisfaction can be one of a substantially green image, a substantially yellow image, or a substantially red image.

15. The computer-readable storage medium of claim 12, wherein said rules are used to determine satisfaction level based on one or more of the following:
number of dissatisfaction reports;
number of elevated account supervisor incidents;
number of manager callbacks;
number of upper level tickets; or
number of complaints received.

16. The computer-readable storage medium of claim 15, wherein said rules are based on customer complaints.

17. The computer-readable storage medium of claim 12, wherein said rules are used to determine satisfaction level based on number of inbound contacts received by said service provider, said inbound contacts relating to one or more of the following activities:
complaints;
reliability;
conservation programs;
customer requests;
collections; or
bill payment.

18. The computer-readable storage medium of claim 11, wherein a first widget is configured to display said customer profile information.

19. The computer-readable storage medium of claim 11, wherein a first widget is configured to display said energy usage data, wherein said energy usage data comprises a history of voltage regulation for the customer's premises.

20. The computer-readable storage medium of claim 19, wherein said widget displays a threat alert.
